(19) United States
(12) Patent Application Publication
(10) Pub. No.: US 2015/0237480 A1
(43) Pub. Date: Aug. 20, 2015

(54) INDOOR POSITIONING METHOD, INDOOR POSITIONING SYSTEM, AND COMPUTER-READABLE MEDIUM

(71) Applicant: INDUSTRIAL TECHNOLOGY RESEARCH INSTITUTE, HSINCHU (TW)

(72) Inventors: Shih-Hau FANG, Taipei (TW); Yung-Wei KAO, Taipei (TW); Lun-Chia KUO, Taichung (TW); Wan-Jung LIN, New Taipei (TW); Fan-Yu SUNG, Taipei (TW)

(21) Appl. No.: 14/473,678

(22) Filed: Aug. 29, 2014

(30) Foreign Application Priority Data
Feb. 14, 2014 (TW) 103104965

(51) Int. Cl. H04W 4/04; H04W 64/00

(52) U.S. Cl. CPC H04W 4/04; H04W 64/003

(57) ABSTRACT

An indoor positioning system comprises at least one signal source disposed in an indoor environment having training points, and storage and positioning devices coupled with each other. The signal source has power levels, based on one of which it transmits a wireless signal. The storage device stores for each training point a first signal strength, and for at least one adaptation point among the training points a second signal strength. The first and second signal strengths are associated respectively with a first and a second power level among the power levels. The positioning device obtains a current signal strength observed at a current location and its associated current power level, calculates a third signal strength for each training point based on the first, second and current power levels and the first and second signal strengths, and compares the current and third signal strengths to estimate the current location.

### CROSS-REFERENCE TO RELATED APPLICATIONS

This non-provisional application claims priority under 35 U.S.C. §119(a) on Patent Application No. 103104965 filed in Taiwan, R.O.C. on Feb. 14, 2014, the entire contents of which are hereby incorporated by reference.

### TECHNICAL FIELD

The present disclosure relates to an indoor positioning method and an indoor positioning system providing fingerprint-based positioning service where a signal source is of variable transmit power.

### BACKGROUND

To provide fingerprint-based indoor positioning as an application of, say, a wireless local area network consisting of access points installed in an indoor environment, one must first measure at various coordinates of the indoor environment the received signal strength (RSS) from each access point in order to create a “radio map.” Thereafter, when a user enters the indoor environment and wants to know where they are, they take their own RSS measurements of the access points and pattern-match the measurements against the radio map. The coordinates on the radio map having characteristics identical or similar to those received by the user indicate their current location.

The transmit power of each access point, however, often experiences dynamic and independent adjustments during the operation of the wireless local area network, whether the adjustments are manually done by an administrator or are an automation prescribed in IEEE 802.11h. Because the adjusted power is different from that when the radio map is created, insisting on performing pattern matching with RSS and the radio map will obviously result in serious mismatch and positioning error. An intuitive solution is to measure the RSS of all the access points under all their possible transmit powers and create a multitude of radio maps, a labor- and time-intensive proposition impractical even for a building of moderate dimensions.

### SUMMARY

The present disclosure provides a method and a system of indoor positioning, wherein mismatch and positioning error in fingerprinting are reduced by adapting the radio map with scalable measurements to reflect the current transmit power of a signal source used in positioning.

The indoor positioning method, according to this disclosure, provides positioning service for an indoor environment. The indoor environment has a plurality of training points and is disposed with at least one signal source. The signal source has a plurality of power levels. The indoor positioning method comprises: obtaining, during a first time interval, a current signal strength based on a wireless signal, the wireless signal transmitted by the signal source and received at a current location of the indoor environment; obtaining a current power level based on which the signal source transmits the wireless signal during the first time interval, the current power level being among the power levels; obtaining a first signal strength of each training point, the first signal strength associated with a first power level among the power levels; obtaining a second signal strength of at least one adaptation point among the training points, the second signal strength associated with a second power level among the power levels; calculating a third signal strength for each training point based on the first, second, and current power levels and the first and second signal strengths; and comparing the current signal strength with the third signal strength so as to estimate the current location based on the indoor environment.

Also disclosed herein is a computer-readable medium having computer program code for causing a processor to perform a plurality of instructions for processing a positioning request with regard to an indoor environment. The indoor environment has a plurality of training points and is disposed with at least one signal source. The signal source has a plurality of power levels. The instructions comprise: obtaining a current signal strength based on a wireless signal, the wireless signal transmitted by the signal source and received at a current location of the indoor environment; obtaining a current power level based on which the signal source transmits the wireless signal, the current power level being among the power levels; obtaining a first signal strength of each training point, the first signal strength associated with a first power level among the power levels; obtaining a second signal strength of at least one adaptation point among the training points, the second signal strength associated with a second power level among the power levels; calculating a third signal strength for each training point based on the first, second, and current power levels and the first and second signal strengths; and comparing the current signal strength with the third signal strength so as to estimate the current location based on the indoor environment.

The indoor positioning system, according to this disclosure, provides positioning service for an indoor environment. The indoor environment has a plurality of training points. The indoor positioning system comprises at least one signal source, a storage device, and a positioning device. The signal source, disposed in the indoor environment and having a plurality of power levels, transmits a wireless signal based on one of the power levels. The storage device stores a first signal strength for each of the training points and stores a second signal strength for at least one adaptation point among the training points. The first and second signal strengths are respectively associated with a first and a second power level among the power levels. The positioning device is coupled with the storage device. The positioning device obtains a current signal strength based on a current wireless signal, the current wireless signal transmitted by the signal source and received at a current location of the indoor environment. The positioning device obtains a current power level based on which the signal source transmits the current wireless signal, the current power level being among the power levels. The positioning device calculates a third signal strength for each of the training points based on the first, second, and current power levels and the first and second signal strengths. The positioning device compares the current signal strength with the third signal strength so as to estimate the current location based on the indoor environment.

In short, the present disclosure enables the dynamic generation of a radio map under any current power level using the overall radio map under the first power level and the RSS at a minority of the training points (the adaptation point) under the second power level, taking advantage of the linear relationship between the power levels. When there is more than one signal source in the indoor environment, on the radio map there will be more characteristics with which the current signal strength can be compared, increasing the accuracy in estimating the current location.

### BRIEF DESCRIPTION OF THE DRAWING

The present disclosure will become more fully understood from the detailed description given hereinbelow and the accompanying drawings which are given by way of illustration only and thus are not limitative of the present disclosure and wherein:

FIG. 1 is a high-level block diagram of an indoor positioning system, in accordance with an embodiment of the present disclosure.

FIG. 2 illustrates signal sources disposed in an indoor environment.

FIG. 3 is a flowchart of the offline stage of an indoor positioning method, in accordance with an embodiment of the present disclosure.

FIG. 4 is a flowchart of the online stage of an indoor positioning method, in accordance with an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

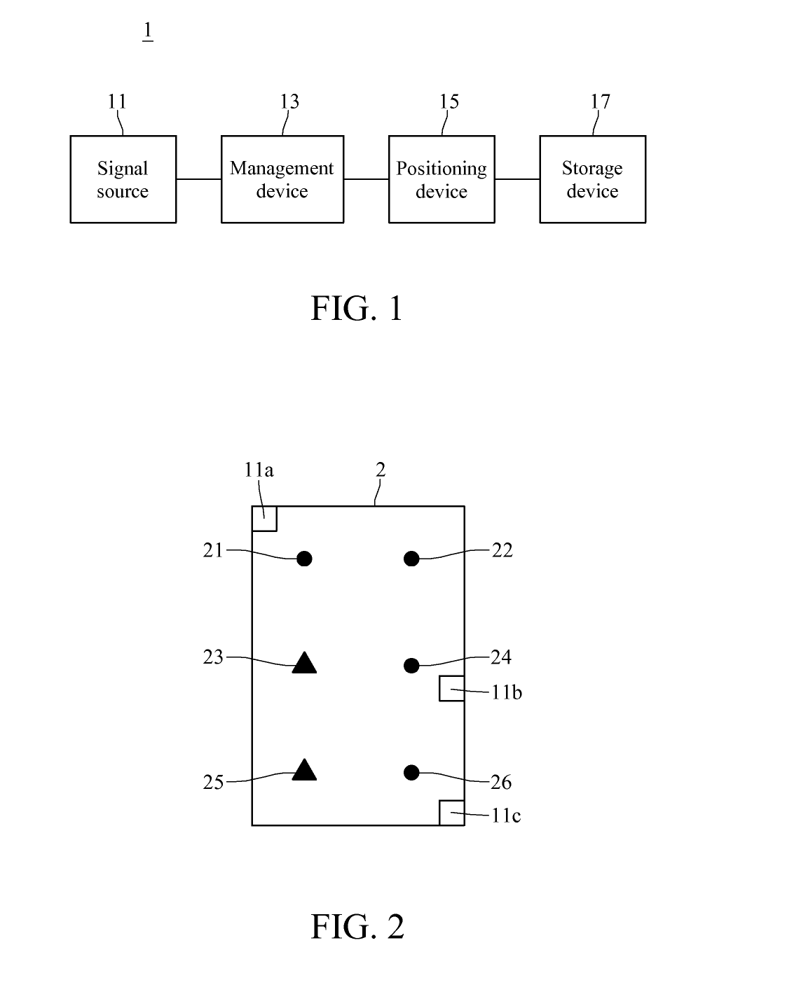

FIG. 1 is a high-level block diagram of an indoor positioning system, in accordance with an embodiment of the present disclosure. Please refer to FIG. 1. In the present embodiment, an indoor positioning system 1 providing positioning service for an indoor environment comprises at least one signal source 11, a management device 13, a positioning device 15, and a storage device 17. The indoor environment has a plurality of training points. The signal source 11, disposed in the indoor environment and coupled with the storage device 17, has a plurality of power levels and transmits a wireless signal based on one of the power levels. The signal source 11 may be a constituent of a wireless local loop, such as a Wi-Fi or WiMAX (Worldwide Interoperability for Microwave Access) access point or gateway, or the signal source 11 may belong to a wireless sensor network, being a sensor complying with the ZigBee or ISA100.11a standard for example. The management device 13 is not an indispensable component of the indoor positioning system 1. In one embodiment, the signal source 11 is subject to the management device 13, in that the management device 13 may decide the power level based on which the signal source 11 transmits its wireless signal. Formally speaking, the management device 13 configures the signal source 11, causing the signal source 11 to transmit the wireless signal based on one of the power levels. In other embodiments, the signal source 11 may inspect and adjust itself based on network conditions. The positioning device 15 processes positioning requests with regard to the indoor environment in which the signal source 11 is disposed, and selectively generates or provides the aforementioned adapted radio map (comprising the third signal strengths). Depending on the existence of the management device 13, the positioning device 15 may inquire directly of the signal source 11 about the power level currently in use, or the management device 13 may provide the positioning device 15 with such information. The storage device 17 stores a first signal strength for each of the training points and stores a second signal strength for at least one adaptation point among the training points, the first signal strength associated with a first power level among the power levels, the second signal strength associated with a second power level among the power levels. In other words, the storage device 17 stores the overall radio map under the first power level (the overall radio map comprising the first signal strengths) and the adaptation data obtained at one or a few locations of the indoor environment under the second power level (the adaptation data comprising the second signal strength[s]). In contrast to the signal source 11, which is disposed in the indoor environment, the trio of the management device 13, the positioning device 15, and the storage device 17 may be geographically unrelated to the indoor environment. The trio may be dedicated equipment, or implemented in part on general-purpose servers or computers.

The positioning device 15 is coupled with the storage device. The positioning device 15 obtains a current signal strength based on a current wireless signal, the current wireless signal transmitted by the signal source 11 and received at a current location of the indoor environment. The positioning device 15 obtains a current power level based on which the signal source 11 transmits the current wireless signal, the current power level being among the power levels. The positioning device 15 calculates a third signal strength for each of the training points based on the first, second, and current power levels and the first and second signal strengths. The positioning device 15 compares the current signal strength with the third signal strength so as to estimate the current location based on the indoor environment. In the present embodiment, the positioning device 15 obtains the current power level from or through the management device 13.

FIG. 2 illustrates signal sources disposed in an indoor environment. Please refer to FIG. 2. In the present embodiment, training points 21 to 26 are scattered in an indoor environment 2, which is also disposed with a plurality of signal sources 11a to 11c. The training points 23 and 25 are meanwhile chosen as adaptation points. Every signal source 11a, 11b, or 11c transmits its own wireless signal. For example, if the wireless signal from the signal source 11b is picked up at the training point 21, the strength of this wireless signal is recorded for the training point 21; if the wireless signal from the signal source 11a is not received at the training point 26, the signal strength of the signal source 11a is recorded as zero for the training point 26. As described above, a radio map records the signal strength at every training point for each signal source in an indoor environment. The indoor environment 2 is disposed with six training points 21 to 26 and three signal sources 11a to 11c, so there should be eighteen values on the entire radio map. The signal sources 11a to 11c are independent in terms of the adaptational calculation of the present disclosure; therefore, for purposes of illustration, only the signal source 11a is referred to in the following description, and it is expected that a person skilled in the art is able to deduce how to perform indoor positioning when there are multiple signal sources. Furthermore, the signal source 11a is capable of transmitting the wireless signal based on a plurality of power levels and thus affecting the RSS. For example, the signal source 11a may have seven power levels 1 through 7, an adjacent pair of which corresponding to a power difference of 3 dBm. Level 1 may represent −1 dBm, level 2 may represent 2 dBm, and level 7 may represent 17 dBm, the levels equivalent to transmit powers ranging from 0.78 to 50 milliwatts.

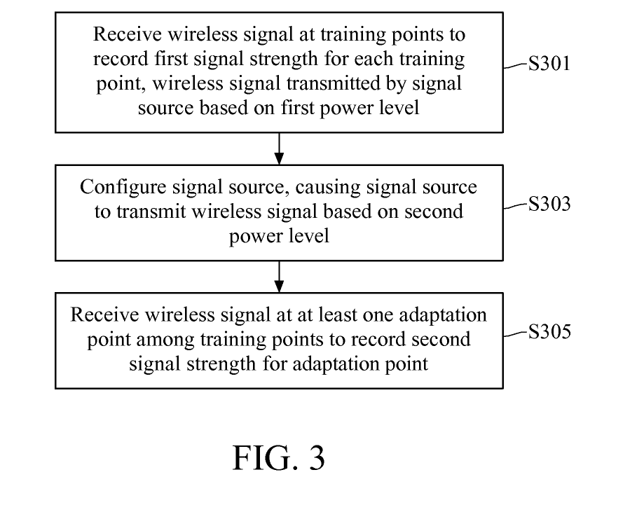

With regard to FIGS. 1 and 2, please refer to FIG. 3, which illustrates the offline stage of an embodiment of the indoor positioning method. Step S301 reads “receiving the wireless signal at the training points during a second time interval so as to record the first signal strength for each of the training points, the wireless signal transmitted by the signal source based on the first power level during the second time interval, the second time interval preceding a first time interval (see below).” Step S303 reads “configuring the signal source during a third time interval, causing the signal source to transmit the wireless signal based on the second power level during the third time interval, the third time interval coming after the second time interval and preceding the first time interval.” Step S305 reads “receiving the wireless signal at the at least one adaptation point during the third time interval so as to record the second signal strength for the adaptation point.” The second time interval is distinguished from the third time interval and the first time interval to signify the temporal relationship of the steps.

The offline stage is the steps required to create a basic radio map and adaptation data. As shown in the flowchart, the wireless signal that the signal source 11a transmits based on the first power level is first received S301 at all the training points 21 to 26. The first power level may be a default of the signal source 11a, or a common or mandatory value set manually or by the management device 13 for the indoor environment 2.

Recording for all the training points 21 to 26 the first signal strengths thereat yields a radio map under the first power level. The signal source 11a is then configured S303 to transmit the wireless signal based on the second power level. The wireless signal is again received S305 at the training (adaptation) points 23 and 25 so that the second signal strengths are recorded. The second signal strengths, as the adaptation data, can be employed to adapt the radio map which is based on the first signal strengths. The said radio map and adaptation data may be kept in the storage device 17. This disclosure is suitable for indoor environments of diverse dimensions because of the freedom in the selection of adaptation points, bringing spatial scalability to fingerprint-based positioning.

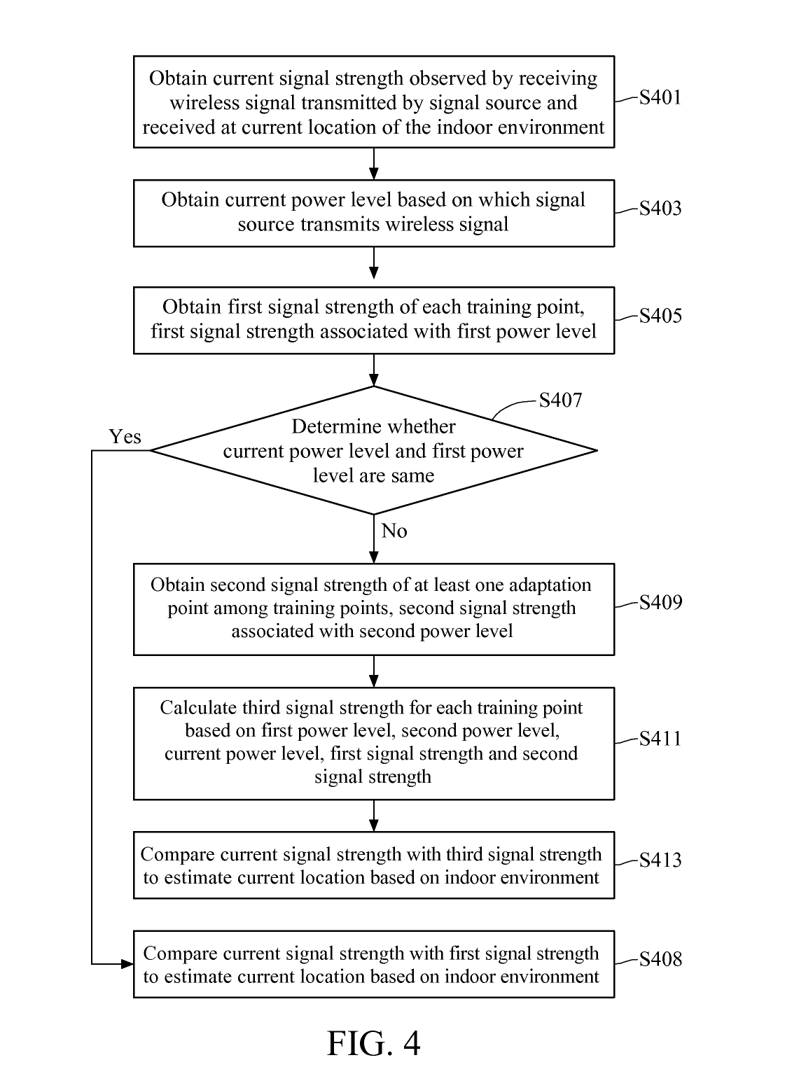

With regard to FIGS. 1 and 2, please refer to FIG. 4, which illustrates the online stage of an embodiment of the indoor positioning method. The online stage is the steps of generating an adapted radio map in response to a positioning request. A mobile device (e.g. a mobile telephone, a tablet or a laptop computer) entering the indoor environment 2 may wish to know its current location in the indoor environment 2 and send the positioning request. The positioning device 15, receiving the request, processes it by obtaining S401 the current signal strength received by the mobile device from the signal source 11a at the current location in the indoor environment 2 (during the first time interval, which is later than the second and third time intervals of the offline stage). From the management device 13 or the signal source 11a itself, the positioning device 15 obtains S403 the current power level based on which the signal source 11a presently transmits the wireless signal, the current power level being among the power levels. The positioning device 15 obtains S405 the first signal strength of each training point. The first signal strengths are associated with the first power level among the power levels. In other words, the positioning device 15 obtains S405 from the storage device 17 the radio map based on the first power level. The positioning device 15 determines S407 whether the current power level obtained S403 through inquiry is the same as the first power level. If it is, the current signal strength is compared S408 with the basic radio map comprising the first signal strengths and the positioning device 15 estimates the current location based on the indoor environment 2, for example with an interior layout thereof. If it is not, the adaptation data comprising the second signal strengths is obtained S409 from the storage device 17. The second signal strengths are associated with the second power level and of the adaptation points 23 and 25 among the training points 21 to 26. The positioning device 15 calculates S411 the adapted radio map (comprising the third signal strengths of the training points 21 to 26) to be used in step S413 based on the first, second, and current power levels and the first and second signal strengths, or in other words the basic radio map, the adaptation data, and the current power level. The positioning device 15 compares S413 the current signal strength with the third signal strengths so as to estimate the current location based on the indoor environment 2.

Given the limited amount of power levels in the signal sources 11a to 11c, at the offline stage different “third power levels” may be assumed and signal strengths automatically generated for these power levels for all the training points 21 to 26. Based on the current power level, the positioning device 15 retrieves the corresponding values at the online stage to generate the radio map.

The adapted radio map includes the third signal strengths of the training points 21 to 26 and simulates the values measured respectively at the training points 21 to 26 if the wireless signal were transmitted based on the current power level at the offline stage. In one embodiment, a third signal strength is a first signal strength added with an adaptation term. In another embodiment, the adaptation term is expressed as

$$( 1 - w ) \cdot s \cdot ( {l}_{3} - {l}_{1} ) + w \cdot ( {a}_{2} - {o}_{1} ) \cdot \frac{{l}_{3} - {l}_{1}}{{l}_{2} - {l}_{1}} ,$$

where w is a weight between 0 and 1, s is a difference in power between two adjacent power levels among the power levels, l₃ is the current power level, l₁ is the first power level, a₂ is the second signal strength, o₁ is the first signal strength, and l₂ is the second power level. In terms of the aforesaid exemplary specification of the signal source 11a, assume that the first power level is level 1, the second power level is level 7, and the current power level is level 6, then s=3 dBm, l₃=6, l₁=1, l₂=7, whereas the unit of a₂ and o₁ can be converted to dBm. It is evident in the expression that the adaptation term includes a theoretical value (related to s) and a measured value (related to a₂ and o₁), the two values added together based on a determined ratio.

When there are a plurality of adaptation points, the third signal strength is calculated for each of the training points based on the second signal strength of one of the adaptation points, that adaptation point being the nearest adaptation point to the training point. In one embodiment, w is set based on a distance between that adaptation point and the training point, or based on a variance of the second signal strength with regard to time.

Specifically, when calculating the third signal strength for a training point, the second signal strength of the most suitable adaptation point is employed. “Most suitable” generally means the nearest; if the training point happens to be an adaptation point, obviously it is most suitable to employ its own second signal strength. The weight w may be solved using simple optimization at the offline or online stage based on the spatial relationship between the training point and the most suitable adaptation point. During the optimization, the objective function may be a cross-validated average positioning error. If the weight is calculated at the offline stage, an optimal solution may be approached using gradient descent, Newton's method, or even heuristic search. The weight may be any reasonable value between 0 and 1. A large w signifies that more trust is given to the second signal strength, which is actually measured, during the adaptation. This may simply indicate that the training point and the chosen adaptation point are relatively close in distance, or it may indicate that the signal strengths under different power levels are relatively not linearly related due to unpredictability in the indoor environment. A small w, besides signifying the opposite of the above, may also represent that the second signal strength is unstable when measured at the offline stage and thus should not be unduly trusted. In the indoor environment 2, for instance, the adaptation points paired with the training points 22 and 24 may be one training point 23. If w is set as 0.6 when calculating the third signal strength of the training point 24, w may be 0.4 for the training point 22 to reflect the fact that it is farther from the adaptation point 23 than the training point 24 is.

The present disclosure also provides a computer-readable medium having computer program code for causing a processor to perform a plurality of instructions for processing a positioning request with regard to an indoor environment. The indoor environment has a plurality of training points and is disposed with at least one signal source. The signal source has a plurality of power levels. The instructions comprise: obtaining a current signal strength based on a wireless signal, the wireless signal transmitted by the signal source and received at a current location of the indoor environment; obtaining a current power level based on which the signal source transmits the wireless signal, the current power level being among the power levels; obtaining a first signal strength of each training point, the first signal strength associated with a first power level among the power levels; obtaining a second signal strength of at least one adaptation point among the training points, the second signal strength associated with a second power level among the power levels; calculating a third signal strength for each training point based on the first, second, and current power levels and the first and second signal strengths; and comparing the current signal strength with the third signal strength so as to estimate the current location based on the indoor environment.

In one embodiment, after obtaining the first signal strength of each of the training points, the said instructions further comprise determining whether the current power level is the same as the first power level. The second signal strength of the at least one adaptation point is obtained if the current power level is not the same as the first power level. The current signal strength is compared with the third signal strength if the current power level is the same as the first power level.

In one embodiment, the third signal strength is the first signal strength added with an adaptation term. In one embodiment, the adaptation term is obtained based on the expression

$$( 1 - w ) \cdot s \cdot ( {l}_{3} - {l}_{1} ) + w \cdot ( {a}_{2} - {o}_{1} ) \cdot \frac{{l}_{3} - {l}_{1}}{{l}_{2} - {l}_{1}} ,$$

where w is a weight between 0 and 1, s is a difference in power between two adjacent power levels among the power levels, l₃ is the current power level, l₁ is the first power level, a₂ is the second signal strength, o₁ is the first signal strength, and l₂ is the second power level.

When there are a plurality of adaptation points, the third signal strength is calculated for each of the training points based on the second signal strength of one of the adaptation points, that adaptation point being the nearest adaptation point to the training point. In one embodiment, w is set based on a distance between that adaptation point and the training point, or based on a variance of the second signal strength with regard to time.

To summarize, the present disclosure provides an indoor positioning system comprising a signal source, a positioning device, a storage device, and an optional management device, and an indoor positioning method consisting of an offline stage and an online stage. Based on the overall radio map under the first power level, the RSS at a minority of the training points under the second power level, and the linear relationship between the power levels, the main steps of adapting the radio map can be performed at the offline or the online stage to reflect the current transmit power of a signal source used in positioning and to reduce mismatch and positioning error in fingerprinting. In particular, the adaptation is the calculation of the third signal strength from the first signal strength for each training point, taking into account the spatial relationship between the training and adaptation points, the stability of the second signal strength at the adaptation point, and the overall trust given to the second signal strength.

The foregoing description has been presented for purposes of illustration. It is not exhaustive and does not limit this disclosure to the precise forms or embodiments described. Modifications and adaptations will be apparent to those skilled in the art from consideration of the specification and practice of the disclosed embodiments. It is intended, therefore, that the specification and examples be considered as exemplary only, with a true scope and spirit of this disclosure being indicated by the following claims and their full scope of equivalents.

What is claimed is:

1. An indoor positioning method providing positioning service for an indoor environment, the indoor environment having a plurality of training points and disposed with at least one signal source, the signal source having a plurality of power levels, the indoor positioning method comprising:
obtaining, during a first time interval, a current signal strength based on a wireless signal, the wireless signal transmitted by the signal source and received at a current location of the indoor environment;
obtaining a current power level based on which the signal source transmits the wireless signal during the first time interval, the current power level being among the power levels;
obtaining a first signal strength of each of the training points, the first signal strength associated with a first power level among the power levels;
obtaining a second signal strength of at least one adaptation point among the training points, the second signal strength associated with a second power level among the power levels;
calculating a third signal strength for each of the training points based on the first power level, the second power level, the current power level, the first signal strength, and the second signal strength; and
comparing the current signal strength with the third signal strength so as to estimate the current location based on the indoor environment.

2. The indoor positioning method of claim 1, wherein the third signal strength is the first signal strength added with an adaptation term.

3. The indoor positioning method of claim 2, wherein the adaptation term is obtained based on an expression, the expression being:
$$( 1 - w ) \cdot s \cdot ( {l}_{3} - {l}_{1} ) + w \cdot ( {a}_{2} - {o}_{1} ) \cdot \frac{{l}_{3} - {l}_{1}}{{l}_{2} - {l}_{1}} ;$$
wherein w is a weight between 0 and 1, s is a difference in power between two adjacent power levels among the plurality of power levels, l₃ is the current power level, l₁ is the first power level, a₂ is the second signal strength, o₁ is the first signal strength, and l₂ is the second power level.

4. The indoor positioning method of claim 3, wherein when there are a plurality of adaptation points, the third signal strength is calculated for each of the training points based on the second signal strength of one of the adaptation points, the adaptation point being the nearest adaptation point to the training point.

5. The indoor positioning method of claim 4, wherein the weight is set based on a distance between the adaptation point and the training point, or based on a variance of the second signal strength with regard to time.

6. The indoor positioning method of claim 1, further comprising, after obtaining the first signal strength of each of the training points:
determining whether the current power level is the same as the first power level;
wherein the second signal strength of the at least one adaptation point is obtained if the current power level is not the same as the first power level;
wherein the current signal strength is compared with the first signal strength to estimate the current location based on the indoor environment if the current power level is the same as the first power level.

7. The indoor positioning method of claim 1, further comprising:
receiving the wireless signal at the training points during a second time interval so as to record the first signal strength for each of the training points, the wireless signal transmitted by the signal source based on the first power level during the second time interval, the second time interval preceding the first time interval;
configuring the signal source during a third time interval, causing the signal source to transmit the wireless signal based on the second power level during the third time interval, the third time interval coming after the second time interval and preceding the first time interval; and
receiving the wireless signal at the at least one adaptation point during the third time interval so as to record the second signal strength for the adaptation point.

8. A computer-readable medium having computer program code for causing a processor to perform a plurality of instructions for processing a positioning request with regard to an indoor environment, the indoor environment having a plurality of training points and disposed with at least one signal source, the signal source having a plurality of power levels, the instructions comprising:
obtaining a current signal strength based on a wireless signal, the wireless signal transmitted by the signal source and received at a current location of the indoor environment;
obtaining a current power level based on which the signal source transmits the wireless signal, the current power level being among the power levels;
obtaining a first signal strength of each of the training points, the first signal strength associated with a first power level among the power levels;
obtaining a second signal strength of at least one adaptation point among the training points, the second signal strength associated with a second power level among the power levels;
calculating a third signal strength for each of the training points based on the first power level, the second power level, the current power level, the first signal strength, and the second signal strength; and
comparing the current signal strength with the third signal strength so as to estimate the current location based on the indoor environment.

9. The computer-readable medium of claim 8, wherein the third signal strength is the first signal strength added with an adaptation term.

10. The computer-readable medium of claim 9, wherein the adaptation term is obtained based on an expression, the expression being:
$$( 1 - w ) \cdot s \cdot ( {l}_{3} - {l}_{1} ) + w \cdot ( {a}_{2} - {o}_{1} ) \cdot \frac{{l}_{3} - {l}_{1}}{{l}_{2} - {l}_{1}} ;$$
wherein w is a weight between 0 and 1, s is a difference in power between two adjacent power levels among the plurality of power levels, l₃ is the current power level, l₁ is the first power level, a₂ is the second signal strength, o₁ is the first signal strength, and l₂ is the second power level.

11. The computer-readable medium of claim 10, wherein when there are a plurality of adaptation points, the third signal strength is calculated for each of the training points based on the second signal strength of one of the adaptation points, the adaptation point being the nearest adaptation point to the training point.

12. The computer-readable medium of claim 11, wherein the weight is set based on a distance between the adaptation point and the training point, or based on a variance of the second signal strength with regard to time.

13. The computer-readable medium of claim 8, wherein the instructions further comprise, after obtaining the first signal strength of each of the training points:
determining whether the current power level is the same as the first power level;
wherein the second signal strength of the at least one adaptation point is obtained if the current power level is not the same as the first power level;
wherein the current signal strength is compared with the first signal strength to estimate the current location based on the indoor environment if the current power level is the same as the first power level.

14. An indoor positioning system providing positioning service for an indoor environment, the indoor environment having a plurality of training points, the indoor positioning system comprising:
at least one signal source disposed in the indoor environment, having a plurality of power levels, and transmitting a wireless signal based on one of the power levels;
a storage device storing a first signal strength for each of the training points and storing a second signal strength for at least one adaptation point among the training points, the first signal strength associated with a first power level among the power levels, the second signal strength associated with a second power level among the power levels; and
a positioning device coupled with the storage device;
wherein the positioning device obtains a current signal strength based on a current wireless signal, the current wireless signal transmitted by the signal source and received at a current location of the indoor environment;
wherein the positioning device obtains a current power level based on which the signal source transmits the current wireless signal, the current power level being among the power levels;
wherein the positioning device calculates a third signal strength for each of the training points based on the first power level, the second power level, the current power level, the first signal strength, and the second signal strength;
wherein the positioning device compares the current signal strength with the third signal strength so as to estimate the current location based on the indoor environment.

15. The indoor positioning system of claim 14, wherein the third signal strength is the first signal strength added with an adaptation term.

16. The indoor positioning system of claim 15, wherein the positioning device obtains the adaptation term based on an expression, the expression being:
$$( 1 - w ) \cdot s \cdot ( {l}_{3} - {l}_{1} ) + w \cdot ( {a}_{2} - {o}_{1} ) \cdot \frac{{l}_{3} - {l}_{1}}{{l}_{2} - {l}_{1}} ;$$
wherein w is a weight between 0 and 1, s is a difference in power between two adjacent power levels among the plurality of power levels, l₃ is the current power level, l₁ is the first power level, a₂ is the second signal strength, o₁ is the first signal strength, and l₂ is the second power level.

17. The indoor positioning system of claim 16, wherein when there are a plurality of adaptation points, the positioning device calculates the third signal strength for each of the training points based on the second signal strength of one of the adaptation points, the adaptation point being the nearest adaptation point to the training point.

18. The indoor positioning system of claim 17, wherein the positioning device sets the weight based on a distance between the adaptation point and the training point, or based on a variance of the second signal strength with regard to time.

19. The indoor positioning system of claim 14, further comprising:
a management device configuring the signal source so that the signal source transmits the wireless signal based on one of the power levels;
wherein the positioning device obtains the current power level from or through the management device.
